(19) United States
(12) Patent Application Publication
(10) Pub. No.: US 2008/0267722 A1
(43) Pub. Date: Oct. 30, 2008

(54) INDEXABLE MILLING INSERT

(75) Inventor: Thomas Jacob, Geesthacht (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: FETTE GMBH, Schwarzenbek (DE)

(21) Appl. No.: 12/103,459

(22) Filed: Apr. 15, 2008

(30) Foreign Application Priority Data
Apr. 26, 2007 (DE) 102007019666.2-14

(51) Int. Cl. B26D 1/12

(52) U.S. Cl. 407/49

(57) ABSTRACT

An indexable milling insert which is attachable on a rotatable tool holder, preferably under an axial angle different from zero, and which is formed by a trapezoidal insert body, with a substantially planar bearing surface, a further substantially planar surface opposite to the same, and with lateral surfaces formed between the same as well as with opposing cutting edges with associated faces and clearance surfaces adjacent to the same, wherein the faces are formed by one worked-in groove and the clearance surfaces by one lateral surface of the insert body at a time, characterised in that the insert body is provided in the form of an equal-sided lozenge with cutting edges on all the edges of the lozenge, wherein on each flat side, two approximately parallel cutting edges with associated faces are provided at a time, and the pairs of cutting edges of one flat side at a time are associated to different edge pairs of the lozenge.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

As is well known, edge millers serve for forming 90°-shoulders. From EP 0 566 984, the entire contents of which is incorporated herein by reference, a trapezoidal indexable cutting insert has become known, with cutting edges on two parallel edges with assigned chip surfaces and clearance surfaces adjacent to the same. Grooves are machined into the chip surfaces, and the clearance surfaces are made to be crowned. The indexable inserts are fixedly arranged in a tool holder, a shaft for instance, such that that the cutting edge describes a circle when the tool holder is rotated. Usually, the indexable inserts are arranged in an angle to the rotational axis (an axial angle). This has an immediate influence on the stability of the tool under load and on the durability of the cutting edge, because smooth cutting is obtained only at a more or less large axial angle.

In an axial angle different from zero and with a straight cutting edge, an accurate 90° angle can not be milled, because leading and trailing end of the cutting edge are not situated on a common cylinder surface. Furthermore, chip angle and clearance angle change across the length of the cutting edge, and as the case may be, the chip angle changes even in its algebraic sign, which is disadvantageous for machining with high quality. Therefore, it has also already become known to use screw-line shaped cutting edges.

From EP 0 392 730, the entire contents of which is incorporated herein by reference, it has become known to adopt a curved form for the cutting edge, namely as an intersection line of a planar section through a cylinder. The angle of the intersection line corresponds to the axial angle. In this way, it is made sure that the intersection edge is situated on a cylinder surface, and an accurate 90°-angle can be produced with the miller.

As is well known, indexable milling inserts are disposable tools. The known insert can be reversed once and thereafter it can be used no more.

However, it is also known to use indexable inserts having four cutting edges. The same are quadratic. However, they have the following disadvantages: in indexable inserts for edge millers, a long cutting edge is desired. In order to obtain the same length with quadratic indexable cutting inserts as with oblong indexable cutting inserts, the quadratic cutting inserts must be selected to be very large. Therefore, the have a correspondingly large cutting radius. In addition, the materials consumption is very high. A further disadvantage is that with quadratic indexable cutting inserts, the respective neighbouring cutting edge at the upper end of the working cutting edge is also loaded. This is disadvantageous for the subsequent cutting use of this cutting edge.

The present invention is based on the objective to provide an indexable milling insert with four cutting edges, which are independent from each other. In addition, a minimum materials expense is to be required for the indexable cutting insert.

### BRIEF SUMMARY OF THE INVENTION

In the indexable milling insert of the present invention, the insert body is provided in the form of an equal-sided lozenge, with cutting edges on all the edges of the lozenge. One pair of cutting edges with chip surfaces is associated to each flat side, wherein the pairs of cutting edges of one flat side at a time are associated to different edge pairs of the lozenge. In other words, two parallel cutting edges are provided on each side of the insert body, wherein the cutting edges on one side of the insert body are associated to those edges of the lozenge which do not have cutting edges on the opposing side.

The indexable milling insert of the present invention can be turned about 180° like usual cutting inserts with two cutting edges, in order to use the next cutting edge. When both cutting edges of one side are used up, the indexable insert of the present invention is set against the support in the tool holder with the other flat side.

The lozenge form allows minimum materials expense for an indexable cutting insert. In addition, it is made sure that the use of one cutting edge does not adversely affect a neighbouring cutting edge.

According to one embodiment of the present invention, a central passage for a fastening screw is provided. In fact, other fixation or clamping means for attaching the indexable milling insert of the present invention in a tool holder are conceivable. The use of a fastening screw is advantageous because of the possibility of rapid exchange and the small expense in particular.

According to one embodiment of the present invention, the cutting edges are curved, preferably convex in a plane laying towards the bearing surfaces. At a given axial angle, it is achieved that the cutting edge is situated on the longitudinal surface of a cylinder when it is turned on the tool holder.

According to a further embodiment of the present invention, the clearance surfaces are circularly crowned with a great radius. This provides for a camber of the cutting edge and by this for an ideal course in order to generate a 90° surface.

Both lateral surfaces of the insert body of the present invention have planar surface sections adjacent to the clearance surface. Through this, it is possible to put the inserts against corresponding seat surfaces in pockets of the tool holder and to fix the cutting edges securely with respect to the occurring loads.

### BRIEF DESCRIPTION OF THE SEVERAL VIEWS OF THE DRAWINGS

The present invention is explained in more detail in the following by means of drawings.

FIG. 1 shows the top view of an indexable milling insert of the present invention.

FIG. 2 shows the perspective view of the indexable milling insert according to FIG. 1.

FIG. 3 shows a perspective side view of a laying indexable cutting edge according to FIGS. 1 and 2.

FIG. 4 shows a section through the depiction according to FIG. 1, along the line 4-4.

FIG. 5 shows a magnified detail of the section according to FIG. 4.

FIG. 6 shows a shaft miller with indexable milling inserts of the present invention.

FIG. 7 shows a magnified view of the shaft miller according to FIG. 6, with a top view of an indexable milling insert of the present invention.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

An indexable milling insert 10 according to FIG. 1 to 5 has a lozenge shape. The lozenge edges form opposing acute angles 12 and opposing obtuse angles 14a. In the centre, a passage 14 is formed, which will be elaborated in more detail below.

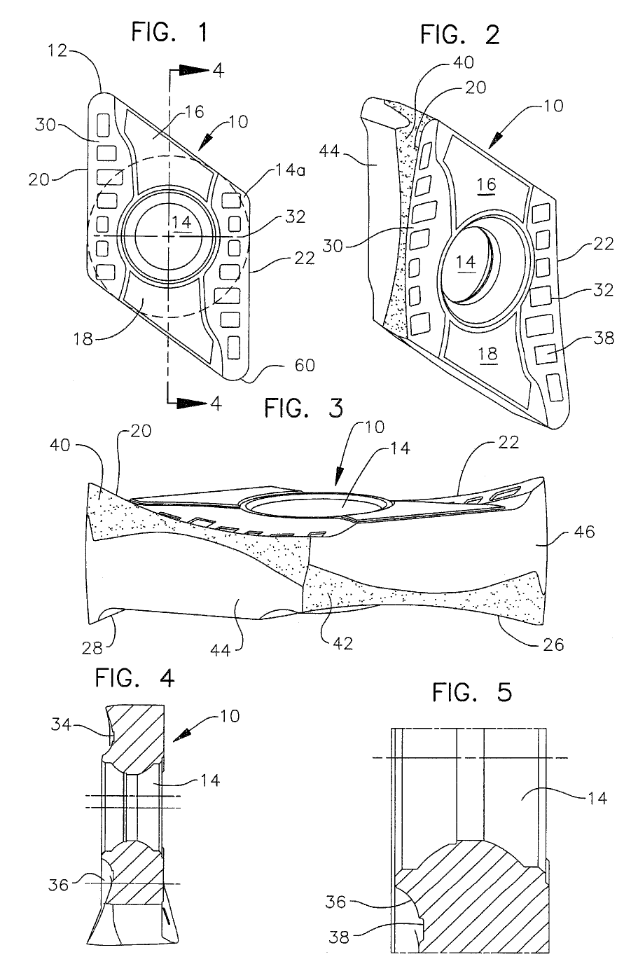

The lozenge-shaped insert body has two flat sides. In FIGS. 1 and 2, one of them at a time is shown pointing away from the drawing plane. The other one points into the drawing plane. Planar bearing surface sections 16, 18 are provided opposing diametrically to the passage 14. In addition, one pair of cutting edges 20, 22 extending substantially parallel belongs to each flat side. As shown in FIG. 3, two approximately parallel cutting edges 26, 28 are also formed on the other flat side. Thus, the insert body 10 has two pairs of cutting edges at a time, wherein each pair of cutting edges is associated to another edge pair of the lozenge-shaped insert body 10.

As is evident from the figures, the cutting edges 20, 22 or 26, 28, respectively, are shaped slightly convex and in addition they are crown bowed (see FIG. 2 for this), in order to form a 90°-surface at a given axial angle. The chip surfaces are formed by grooves 30, 32, or by grooves 34, 36, respectively, (see FIG. 4), into which a series of flat deepenings 38 are formed, which have chip-breaking or chip-influencing properties, respectively.

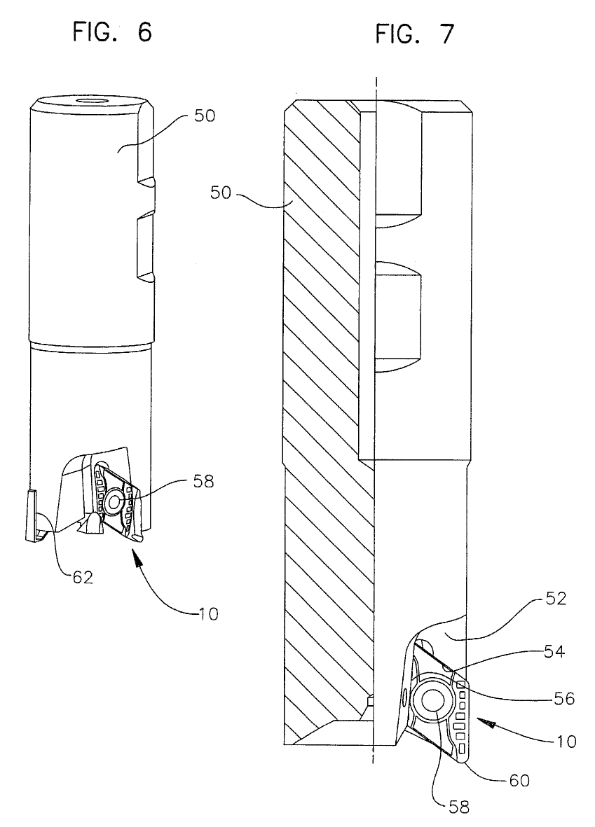

Adjacent to the cutting edges 20, 22 or 26, 28, respectively, clearance surfaces 40 or 42, respectively are provided, which are formed slightly crownedly, as results from the crown bowed form of the cutting edges. Following the clearance surfaces 40, 42, the lateral surfaces of the insert body 10 feature planar bearing sections 44, 46. They serve for the fit on seat surfaces of a tool holder, as is shown in FIG. 6 and 7. In addition, the bearing surfaces 16, 18 serve for the fit on corresponding bearing surfaces in pockets of the tool holder.

In FIGS. 6 and 7, a cylindrical shaft is shown as a tool holder, which has three pockets 52 on its lower end, arranged in distances. Each pocket has three seat surfaces. Two seat surfaces 54, 56 serve for the fit of the bearing surfaces 44, 46 on the lateral surfaces of the insert body 10. The bearing surfaces 18, 16 are supported by corresponding planar seat surfaces 62 in the pockets 52, which can be recognised in FIG. 6. A fastening screw 58 extends through the passage 14 with its shaft and is screwed into corresponding accommodation bores in the pockets 52. The passage 14 has conical entrance sections (see FIGS. 4 and 5) for accommodating the head of the fastening screw 58, so that the head is sunk in the insert body.

As can be further recognised from the figures, the cutting edges 10, 22 or 26, 28, respectively, are rounded in the region of the acute angle 12 and are provided with a corresponding radius, as indicated at 60 in FIG. 1.

As can be recognised, the shown indexable cutting insert has four cutting edges which are independent from each other, which do not disadvantageously influence each other when one cutting edge is used. The materials expense proves to be minimum with the lozenge shape. In addition, even the thickness of the insert body 10 is small. Through this, more inserts can be accommodated on a preset partial circle on the tool holder, than is the case with conventional indexable cutting inserts which have also four cutting edges.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other maimers within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. An indexable milling insert which is attachable on a rotatable tool holder, preferably under an axial angle different from zero, and which is formed by a trapezoidal insert body, with a substantially planar bearing surface, a further substantially planar surface opposite to the same, and with lateral surfaces formed between the same as well as with opposing cutting edges with associated faces and clearance surfaces adjacent to the same, wherein the faces are formed by one worked-in groove and the clearance surfaces by one lateral surface of the insert body at a time, characterised in that the insert body (10) is provided in the form of an equal-sided lozenge with cutting edges (20, 22, 26, 28) on all the edges of the lozenge, wherein on each flat side, two approximately parallel cutting edges (20, 22, 26, 28) with associated faces are provided at a time, and the pairs of cutting edges of one flat side at a time are associated to different edge pairs of the lozenge.

2. An indexable milling insert according to claim 1, characterised in that a central passage (14) for a fastening screw (58) is provided.

3. An indexable milling insert according to claim 2, characterised in that the passage (14) has conical entrance sections at opposing ends thereof.

4. An indexable milling insert according to claim 1, characterised in that the cutting edges (20, 22, 26, 28) are curved, preferably convex in a plane laying towards the bearing surfaces.

5. An indexable milling insert according to claim 1, characterised in that the grooves (30, 32, 34, 36) have a series of deepenings (32).

6. An indexable milling insert according to claim 1, characterised in that all the lateral surfaces have planar surface sections (44, 46) adjacent to the clearance surfaces (40, 42) as bearing surfaces for seat surfaces in a tool holder.

7. An indexable milling insert according to claim 1, characterised in that the clearance surfaces (40, 42) are crownedly circular with a large radius.

8. An indexable milling insert according to claim 1, characterised in that the cutting edges (20, 22, 26, 29) have a radius (60) at the acute angles of the lozenge edges.
